(19) United States
(12) Patent Application Publication
(10) Pub. No.: US 2024/0343533 A1
(43) Pub. Date: Oct. 17, 2024

(54) IRREVERSIBLE HYBRID ASCENT AND/OR DESCENT DEVICE

(71) Applicant: EUROUP S.R.L., Firenze (IT)

(72) Inventor: Paolo BARBAGALLO, Prato (IT)

(21) Appl. No.: 18/684,926

(22) PCT Filed: Aug. 1, 2022
(86) PCT No.: PCT/IB2022/057127

§ 371 Date: Feb. 20, 2024

(30) Foreign Application Priority Data
Aug. 31, 2021 (IT) 102021000022592

(51) Int. Cl. B66F 3/18; F16H 25/22

(52) U.S. Cl. CPC B66F 3/18; F16H 25/2204

(57) ABSTRACT

Described is an ascent/descent device including: motion transmission means, a worm screw mechanism having a main axis of extension, a first nut and a second nut which are both configured to engage with the worm screw mechanism to move along the axis, a pulley positioned concentrically with the worm screw mechanism with the first nut, and elastic means interposed between the first nut and the second nut.

### TECHNICAL FIELD

This invention relates to an irreversible ascent and/or descent device.

### BACKGROUND ART

The ascent and/or descent devices are usually known for moving a load from a surface to a higher surface, and vice versa.

Ascent and/or descent devices are used both in industrial and other contexts, for example residential, as in the case of elevators or lifts.

The prior art includes solutions which comprise the use of a work screw mechanism on which a recirculating ball screw nut is inserted.

Such a coupling is generally of the reversible type, that is to say, such that the nut slides along the axis of the worm screw mechanism, and such that, in order to descend, the nut does not need to be fed by transmission means, as it is possible to use the relative weight, that is, the force of gravity.

In the case of the elevator, a recirculating ball screw nut allows the movement of the elevator cabin both upwards and downwards, in a reversible fashion.

However, these couplings have drawbacks.

A first drawback is due to the fact that in the descending step, the recirculating ball screw nut has the drawback of requiring the use of energy for braking the elevator cabin and for adjusting the speed of descent.

For this reason, the current prior art solutions require the use of auxiliary brakes, which are often redundant, to ensure the braking and stopping of the ascent/descent devices.

### AIM OF THE INVENTION

The aim of the invention is therefore to provide an ascent/descent device which is able to overcome the above-mentioned drawbacks of the prior art.

A further aim of the invention is to provide an ascent/descent device which is at the same time practical to use and simple and inexpensive to make.

According to the invention, these aims and others are achieved by an ascent/descent device having the technical features described in the appended claims.

### BRIEF DESCRIPTION OF THE DRAWINGS

The technical features of the invention, with reference to the above-mentioned aims, are clearly described in the appended claims and its advantages are apparent from the detailed description which follows, with reference to the accompanying drawings which illustrate purely non-limiting example embodiments of the invention, in which:

FIG. 1 is a schematic elevation view of an embodiment of the ascent/descent device according to the invention;

FIG. 2 is an enlarged schematic view of a detail of FIG. 1;

FIG. 3 is a schematic elevation view, with some parts cut away to better illustrate others;

FIG. 4 is a schematic view from above of the device of FIG. 1;

FIG. 5 is a schematic view from above of a further detail of the device of FIG. 1;

FIGS. 6 and 7 are schematic elevation views of the detail of FIGS. 2 and 3 in two different configurations of use.

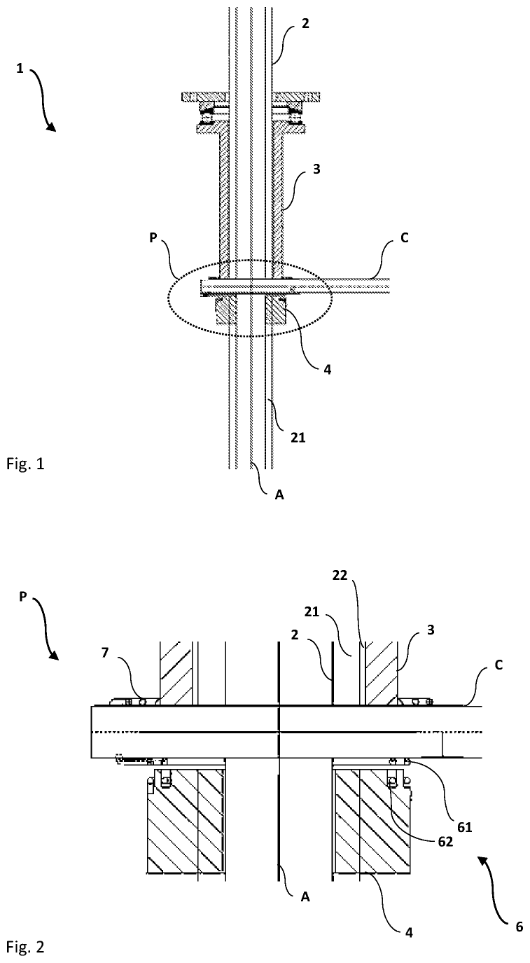

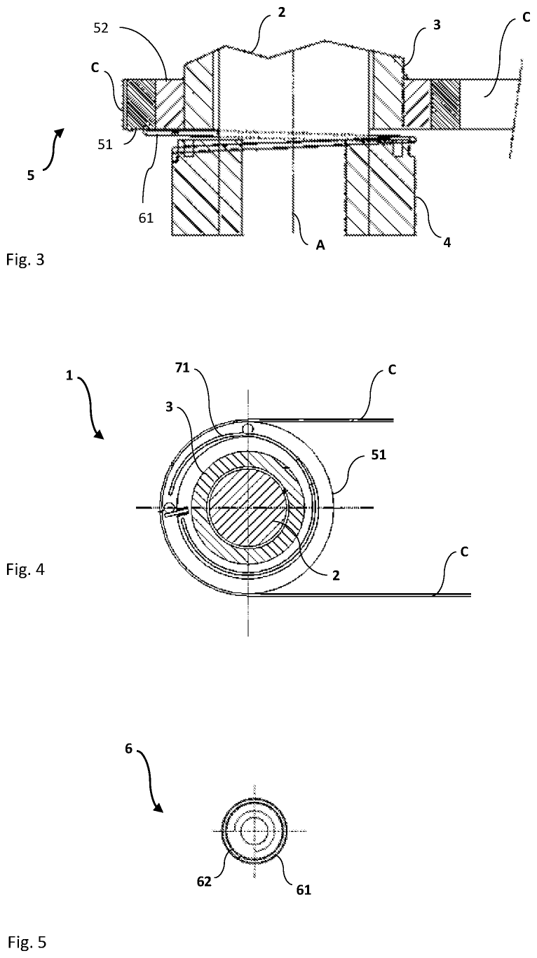

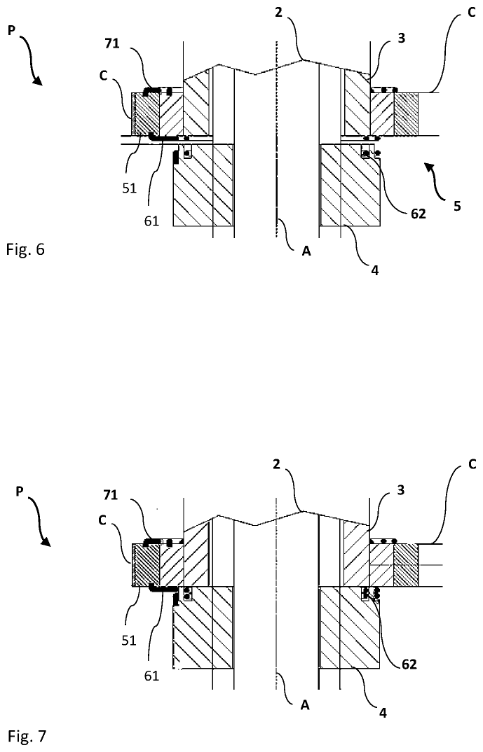

### DETAILED DESCRIPTION OF PREFERRED EMBODIMENTS OF THE INVENTION

With reference to the accompanying drawings, the numeral 1 denotes in its entirety an ascent/descent device made in accordance with the invention, hereinafter also referred to simply as the device 1.

Advantageously, the ascent/descent direction is defined with respect to a horizontal plane or the ground.

With reference to the accompanying drawings, the device 1 comprises: motion transmission means C, a work screw mechanism 2, a first nut 3 and a second nut 4, a pulley or gear, or transmission 5 and elastic means 6.

For example, transmission belts or chains connected to a motor, not illustrated, define transmission means C for the device 1.

In that way, the transmission means C transmit the movement to the pulley 5, and consequently to the first nut 3 and to the second nut 4, as described in more detail below.

The motor transmits a drive torque to the transmission means C.

The worm screw mechanism 2 has a main axis of extension A.

The worm screw mechanism 2 has a thread 21.

The first nut 3 and the second nut 4 are both configured to engage with the worm screw mechanism 2 to move along the axis A.

For this purpose, the first nut 3 and the second nut 4 rotate about the axis A of the worm screw mechanism 2.

This rotation allows the first nut 3 and the second nut 4 to move along the axis A.

In order to move the first nut 3 along the axis A, according to the descent direction, it does not need to be fed by the transmission means C, thus defining a reversible type nut.

If the mechanism 2 is positioned vertically, the first nut 3 is able to slide freely downwards along the axis A of the worm screw mechanism 2.

More specifically, in order to descend along the axis A, of the worm screw mechanism 2, the first nut 3 uses the weight, that is, the action of the force of gravity.

Whilst in order to be able to ascend along the axis A, the first nut 3 must be pushed.

This thrust is applied, for example, by a motor, not illustrated, thanks to the transmission means C, which transfer the motion of the motor to the first nut 3, in the form of drive torque.

In order to be able to be raised, that is to say, to slide along the axis A according to the ascent direction, the second nut 4 must be pulled.

When the second nut 4 is pulled, a force acts on the second nut 4 which is able to pull it along the axis A, as described in more detail below.

The transmission means C do not act directly on the second nut 4, that is to say, it is not necessary for the belt C to engage on the second nut 4.

The first nut 3 is advantageously recirculating ball screw type.

When the first nut 3 is a recirculating ball screw type it is possible to guarantee a high efficiency in the raising and lowering of the first nut 3; during the motion of the first nut 3 it is the only one to withstand the load and the second nut 4, which is of the low efficiency type, is unloaded.

The spheres, not illustrated, of the first nut 3 slide on the surface of the thread 21, of the worm screw mechanism 2.

The spheres slide in the rolling area 22 of the spheres, shown in FIG. 2.

Advantageously, the thread 21 of the worm screw mechanism 2 couples with the profile of the thread of the first nut 3 for the correct rolling of the spheres of the first nut 3.

The second nut 4 has a profile for engagement with said worm screw mechanism 2 having the profile of the thread such as to couple with that of the thread of the recirculating ball screw.

The second nut 4 engages on the thread 21.

Thanks to the thread 21, the second nut 4 is screwed/unscrewed on the worm screw mechanism 2, thus causing an ascent or descent of the nut 4 along the axis A.

Moreover, the irreversible profile of the second nut 4 allows the descent of the first nut 3 to be stopped when the transmission means C are idle, that is to say, when the drive/braking torque is equal to zero.

The combined use of a first nut 3 and a second nut 4, respectively reversible and irreversible, connected to each other, allows the load to be supported which rests on the second nut 4 when stationary, and therefore preventing the descent.

In this way it is possible to make the device 1 by omitting braking devices specifically designed for that purpose.

The second nut 4 does not support the load during the motion steps.

The second nut 4 has a low efficiency, that is to say, such as to guarantee the irreversibility of the motion when not pulled.

The irreversible nature of the motion is also such that even under disturbed conditions the second nut 4 does not rotate on the worm screw mechanism 2 during the lowering, if it is not pulled.

The first nut 3 has a high efficiency, that is to say, it requires a reduced quantity of energy to move along the ascent/descent direction.

Advantageously, the device 1, during the motion steps, acts like a high efficiency device, that is to say, such as to lift the first nut 3 and the second nut 4, and with them the load, using little energy.

During the drive steps, the load rests solely on the nut 3. In effect, during the motion steps on the nut 4 only the relative weight and the thrust of the compression spring 62 rests on the nut which thus rotates with a reduced quantity of energy.

In the step of lowering the load, and the relative nuts 3 and 4, it is possible to recover energy by converting it from potential energy to kinetic energy and, if necessary, from electrical to mechanical energy.

Other embodiments, not illustrated, comprise the use of a dynamo, so that any accumulators are charged during the lowering step and at the same time the lowering speed of the load is adjusted.

The second nut 4, does not work during the motion but performs, always and in any case, safety and stationary functions.

The methods for obtaining a coupling of the reversible or irreversible type are known.

A coupling between a nut and a worm screw mechanism is considered irreversible when the angle of the spiral is less than the friction angle.

In effect, the determination of the type of nut/worm screw mechanism coupling between reversible and irreversible is a design data item for the components and a direct function, for example, of the inclination of the threads used.

From an irreversible coupling between a nut and a worm screw mechanism it follows that the nut, in the absence of external power supply (torques), maintains its position on the worm screw mechanism.

As regards, on the other hand, the reversibility of a nut/worm screw mechanism, this is also a direct function of the geometries of the threads used, and its use means that the nut does not maintain its position on the worm screw mechanism even in the absence of external feeds (torques).

In a reversible type coupling, if the mechanism is a worm screw mechanism and a vertical position, the nut will be free to descend with respect to the same mechanism only due to its weight and force of gravity.

The pulley 5 is positioned concentrically with the worm screw mechanism 2.

In that way, the first nut 3 rotates about the axis A of the worm screw mechanism 2.

The pulley 5 is driven by the transmission means C to make the first nut 3 slide along the axis A according to the ascent/descent direction.

Advantageously, the pulley 5 comprises a rotating body 51 configured to engage with the transmission means C and a hub 52 of the rotating body 51 configured to be connected to the first nut 3.

In that way, a rotation of the rotary body 51 corresponds to an ascent or a descent of the first nut 3.

The elastic means 6 are interposed between the first nut 3 and the second nut 4.

Advantageously, of the two elastic means 6, a first end is connected with a first end to the pulley 5 and with the second end to the first nut 3, and the second elastic means with a first end again to the pulley 5 and with its second end to the second nut 4, in such a way that the rotation of the pulley 51 and therefore of the first nut 3 and its movement along the worm screw mechanism nut 2 transmits with it the second nut 4

More specifically, the first spring 61 is connected to the rotary body 51 of the pulley 5.

Advantageously, the first spring 61 is of the spiral type also known as the “winding spring”.

The spring 61 allows the second nut 4 to be drawn towards the nut 3 during the movement step.

That is to say, when the nut 3 picks up the load because it has started to rotate upwards and therefore unloads the nut 4, the spring 61 recalls the nut 4 towards the nut 3 and, consequently, the nut 4 can no longer brake with its irreversibility.

The nut 3 ascends and picks up the load on itself, the nut 4 is no longer loaded and then starts to move following, pulled by the spring 61.

With reference to the accompanying drawings, the elastic means 6 comprise a second spring 62, a compression spring, positioned with a first end of it resting on the first nut 3, and connected at its second end to the second nut 4.

Advantageously, the second spring 62 is of the compression type, also known as the “helicoidal spring”.

The device 1 also comprises elastic return means 7 for the pulley 5, connected at a first end to the rotating body 51, and at a second end of them to said hub 52.

The elastic return means 7 comprise a spring 71 of a spiral type.

In use, the device 1 adopts different configurations.

The drive torque generated by the motor, not illustrated, is transmitted to the pulley 5 thanks to the transmission means C.

### Stationary Condition:

When the drive torque is absent, the device 1 adopts a first stationary configuration, shown in FIG. 7.

According to this configuration, the first nut 3 rests on the second nut 4.

In effect, the reversibility of the first nut 3 causes its descent until its downward motion is stopped by the second nut 4.

The second nut 4 tends to remain stationary since it is irreversible, and is pushed, and therefore braked, against the thread by the spring 62, and it is also pushed against the thread by its own weight.

The second nut 4, when the drive torque is zero, is stationary at a predetermined point along the axis A of the worm screw mechanism 2.

The second spring 62 is compressed by the first nut 3 which, being reversible, unscrews and rests on the nut 4 (FIG. 7).

The device, 1, braked by the friction between the second nut 4, which now supports the entire load, and the thread 21 of the worm screw mechanism 2, remains stationary in a predetermined position along the axis A.

Ascent/descent condition:

In order to move the device 1, the pulley 5 starts to rotate without pulling, at least initially, the first nut 3: during this step, the pulley 5 is therefore idle and only tensions the elastic means 61.

The pulley 5 continuing to rotate, and no longer being idle, after having rotated a little the nut 3 upwards, has released the second irreversible nut 4 from the load.

Two conditions are superposed, the second nut 4 starts to rotate, and the pulley 5 is no longer idle.

Until the drive torque is applied to the pulley 5, the first nut 3 advances along the axis A of the worm screw mechanism 2, driving the second nut 4 with it, thanks to the elastic means 6, as shown in FIG. 6.

The direction of travel, between the ascent direction and the descent direction can be reversed.

That is to say, the first nut 3 under the action of the force of gravity starts to descend along the axis A, whilst the motor acts as a brake.

Starting downwards is not possible: it is therefore necessary to apply a drive torque to lift the first nut 3 and the direction of travel can then be reversed.

When the drive torque is not applied, the spring 71 pulls the pulley 5 back to the stationary position, that is to say, to the first configuration of FIG. 7, described above.

Every time the drive torque is missing, the device 1 returns to the first stationary configuration.

The ascent/descent device according to the invention achieves the preset aims and brings further important advantages.

A first advantage of the ascent/descent device according to the invention is the possibility of braking the reversible couplings between nut and worm screw mechanism.

A further advantage is the possibility of reducing the energy consumption for the ascent/descent of loads.

A further advantage is due to the fact that the device according to the invention has a high level of reliability, since the stopping is automatic and determined by basic mechanical principles, regardless of the type of possible fault, for example of the electrical type, for example of the electrical type or wear of the mechanical components or of the braking elements.

Yet another advantage is the possibility of reducing the lubrication of the device to a minimum.

A further advantage is due to the fact that the device according to the invention withstands high loads very well: in effect, the greater the load the greater is the stopping stability of the device 1.

Yet another advantage is the possibility of using the device 1 for elevators and lifts or devices designed to push in a single direction. A further advantage is due to the fact that the device according to the invention allows solutions to be made which are highly customisable at limited costs.

1. An ascent/descent device, comprising:
motion transmission means,
a worm screw mechanism having a main axis of extension,
a first nut and a second nut configured to both engage with said worm screw mechanism to move along said axis,
a pulley positioned concentrically with said worm screw mechanism to rotate about said axis of said worm screw mechanism, said pulley being driven by said transmission means so as to slide said first nut along said axis according to said ascent/descent direction;
elastic means interposed between said first nut and said second nut, and connected at one end to said second nut, in such a way that the feeding of said first nut along said mechanism withdraws with it said second nut, wherein:
a) said first nut being of the reversible type, for descending along said axis according to said ascent/descent direction without being fed by said transmission means, and
B) said second nut being of the irreversible type, for descending along said axis according to said ascent/descent direction only when fed by said transmission means.

2. The device according to claim 1, wherein said first nut is recirculating ball screw type.

3. The device according to claim 1, wherein the second nut has a profile for engaging with the worm screw mechanism having an irreversible thread which can be connected to the profile of said first nut.

4. The device according to claim 1, wherein said elastic means comprise a first spring connected at one end of it to the first nut, and at a second end of it to the second nut, wherein the first spring is of a spiral type.

5. The device according to claim 1, wherein said elastic means comprise a second compression spring positioned with a first end of it resting on said first nut and connected at a second end of it to the second nut.

6. The device according to claim 5, wherein the second spring is concentric to said first spring.

7. The device according to claim 1, wherein the pulley comprises a rotating body configured to engage with said transmission means and a hub of said rotating body configured to be connected to said first nut, characterised in that wherein it comprises elastic return means of said pulley, connected at a relative first end to said rotary body, and at a relative second end to said hub.

8. The device according to claim 7, wherein said elastic return means comprise a spring of a spiral type.
